(19) United States
(12) Patent Application Publication
(10) Pub. No.: US 2016/0042025 A1
(43) Pub. Date: Feb. 11, 2016

(54) SYSTEMS AND METHODS FOR DATA CONFIGURATION AND MANIPULATION

(71) Applicant: Bank of America Corporation, Charlotte, NC (US)

(72) Inventors: Nathaniel B. Marocco, Chicago, IL (US); Catherine A. Worth, Jacksonville, FL (US); John E. Scully, Chicago, IL (US)

(21) Appl. No.: 14/506,874

(22) Filed: Oct. 6, 2014

Related U.S. Application Data
(60) Provisional application No. 62/035,047, filed on Aug. 8, 2014.

(51) Int. Cl. G06F 17/30; G06Q 10/10

(52) U.S. Cl. CPC G06F 17/30371; G06Q 10/10; G06Q 40/02

(57) ABSTRACT

An apparatus for data configuration and manipulation is provided. The apparatus may include a receiver. The receiver may be configured to receive a trigger. The trigger may include a field, a qualifier and a value. The receiver may also be configured to receive an executable. The executable may include an action, a parameter and a location. The apparatus may include a database. The database may include a plurality of transactions. The apparatus may include a processor. The processor may be configured to determine, using the trigger, from among the plurality of transactions, all relevant transactions. Each relevant transaction may be selected because the relevant transaction includes the value qualified by the qualifier. The processor may also be configured to alter each relevant transaction by executing the executable, wherein the parameter may be passed to the actions, and the actions may be executed in the location of each relevant transaction.

### CROSS-REFERENCE TO A RELATED APPLICATION

The patent application is a non-provisional of U.S. Provisional Patent Application No. 62/035,047, entitled, “METHOD AND APPARATUS FOR DATA CONFIGURATION AND MANIPULATION”, filed Aug. 8, 2014.

### FIELD OF TECHNOLOGY

The disclosure relates to data configuration. Specifically, the disclosure relates to data manipulation of transaction information.

### BACKGROUND OF DISCLOSURE

Many entities have complex data needs with respect to detailed transaction information. Each entity may require different data configuration which matches their respective software requirements. These entities expect financial institutions to configure reporting data and transmit the configured data within tight implementation timeframes.

A need for more detailed transaction information, or a change in the way transaction information is presented, may be identified in the middle of entity implementation. Because a change in the data configuration may be required in the middle of entity implementation, it may be necessary to configure the change quickly and easily.

Therefore, a need exists for a reporting hub, or data configuration utility, which is implemented on an easy-to-use platform, and reacts quickly to entity requests.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows illustrative apparatus in accordance with the principles of the invention;

FIG. 3 shows illustrative diagram in accordance with the principles of the invention;

FIG. 4 shows illustrative diagram in accordance with the principles of the invention;

FIG. 5 shows illustrative diagram in accordance with the principles of the invention;

FIG. 6 shows illustrative diagram in accordance with the principles of the invention;

FIG. 7 shows illustrative diagram in accordance with the principles of the invention; and

FIG. 8 shows illustrative diagram in accordance with the principles of the invention.

### DETAILED DESCRIPTION OF THE DISCLOSURE

An apparatus for data presentation and manipulation is provided. The apparatus may include a receiver. The receiver may be configured to receive a trigger. The trigger may include a field, a qualifier, and a value.

It should be appreciated that the qualifier may include a plurality of qualifiers joined using logical expressions, for example equals or less than. In addition, a value may include more than one value joined using logical expressions, for example, 475, 348, or 567.

The receiver may also be configured to receive an executable. The executable may include an action, a parameter, and a location.

The apparatus may also include a database. The database may include a plurality of transactions.

The apparatus may also include a processor. The processor may be configured to determine, preferably using the trigger, from among the plurality of transactions, all relevant transactions. Each relevant transaction may be selected because the relevant transaction comprises the value qualified by the qualifier in the selected field. The processor may be further configured to alter each relevant transaction by executing the action, wherein the parameter is passed to the action, and the action is executed in the location of each relevant transaction.

In some embodiments, the relevant transactions may be copied from the database into a file. The processor may perform the executables as the relevant transactions are being copied into the file. In this embodiment, it should be appreciated that the transaction in the database does not necessarily appear together with the changes. Rather, the transaction, as stored, in the file, may appear with the changes already executed.

The file containing the transaction may be transmitted to an entity from a financial institution. The financial institution may transmit files to a plurality of different entities. Each entity may have a unique entity preference for the presentation of the data elements in the transmitted file.

Many entity preferences relate to the presentation of data elements and the formats in which they appear. These preferences may be based on entity back-end computer systems, or entity treasury software systems. Also, each entity may specify a different location in a transaction for the same data. This means that there is no single solution to data configuration which will universally meet entity expectations. For example, some entities may require a transaction reconciliation ID within a transaction detail field. Some entities may require truncating of leading zeroes for all check numbers. Some entities may require a transaction code to be added to an addenda field, which may or may not be the same as the detail text field. An addenda field may be a single field of a transaction, which a user may view, in order to comprehend what took place in the transaction. Some entities may require a country identifying number, for example, 01234567, while some entities may require an identifying country abbreviation, for example, UK. Some entities may consider a state specific routing number cumbersome, and would prefer a more general, country routing number presented in the routing number field. Therefore, flexibility is a critical factor in the reporting hub, or data configuration utility.

In some embodiments, the data configuration utility may be based on triggers and executables. A trigger may be based on an entity request for a change from a financial institution. A number of triggers may also be system defined at the inception of operating a data configuration utility for a specific entity. A trigger may allow for one or more criteria to define when a specific change should be made, such as, for example, when a transaction reference identification code equals a specific number, for all accounts in a file, and/or for all transactions in a specific country.

An executable may determine where upon what the change defined by the trigger takes place. An executable may be executed in order for the change to occur. Exemplary examples of an executable may be to truncate all leading zeroes for all check numbers, append customer reference number in addenda field, and/or replace a specific routing number with a more general routing number.

The user interface which may accompany the data configuration utility may include a trigger section and an executable section. The trigger section may allow a user to select from a list of parameters, such as, for example, account, financial institution ID, currency code, etc. The trigger section may also allow the user to select from a list of qualifiers, for example, greater than, equal to, contains, does not end with, between, etc. The executable section may allow a user to select one or more actions, such as, for example, truncate from left, replace, append to right, etc. The executable section may also allow a user to enter a parameter, for example, zeroes, ones, or a specific number, which may be passed to the action. The executable section may also allow a user to select the location where the executable should take place. Examples of the location may be customer reference number, amount of transaction, funds type, financial institution reference number, etc.

In certain embodiments, following the altering of a relevant transaction, the processor may be further configured to present an altered relevant transaction to a user via a user interface. The user's interface may preferably conform to execution of the action.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

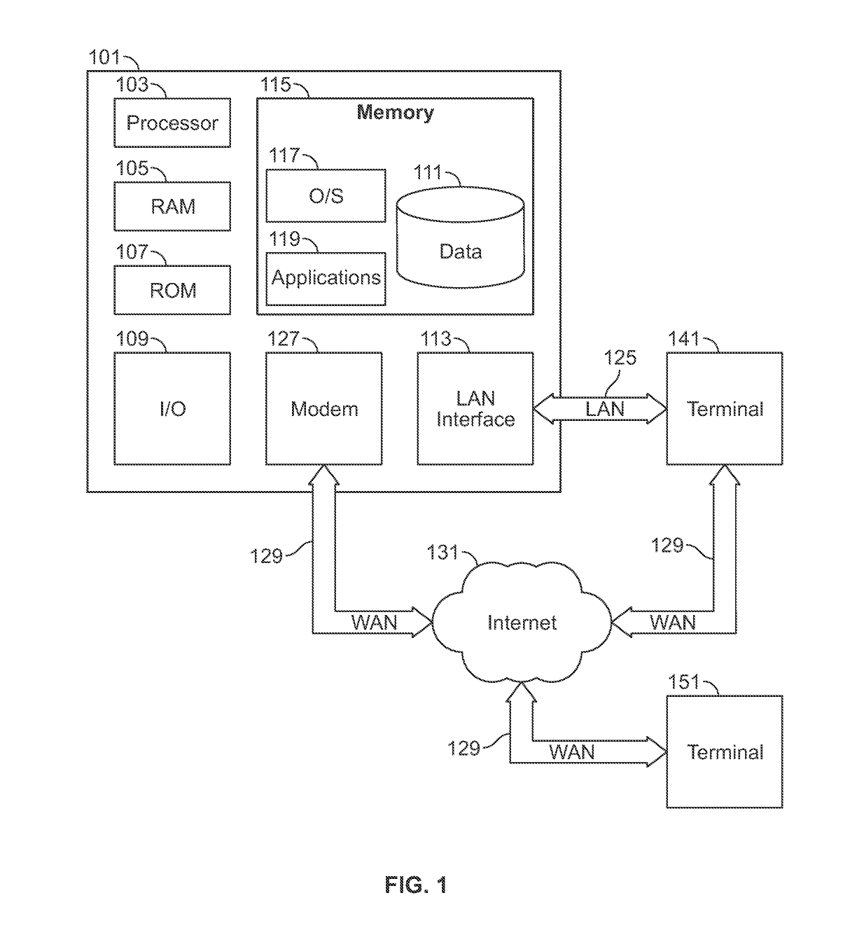

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for transferring information input into one or more of the database(s) described herein, as well as entity information, financial institution information, entity account information, entity software information, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

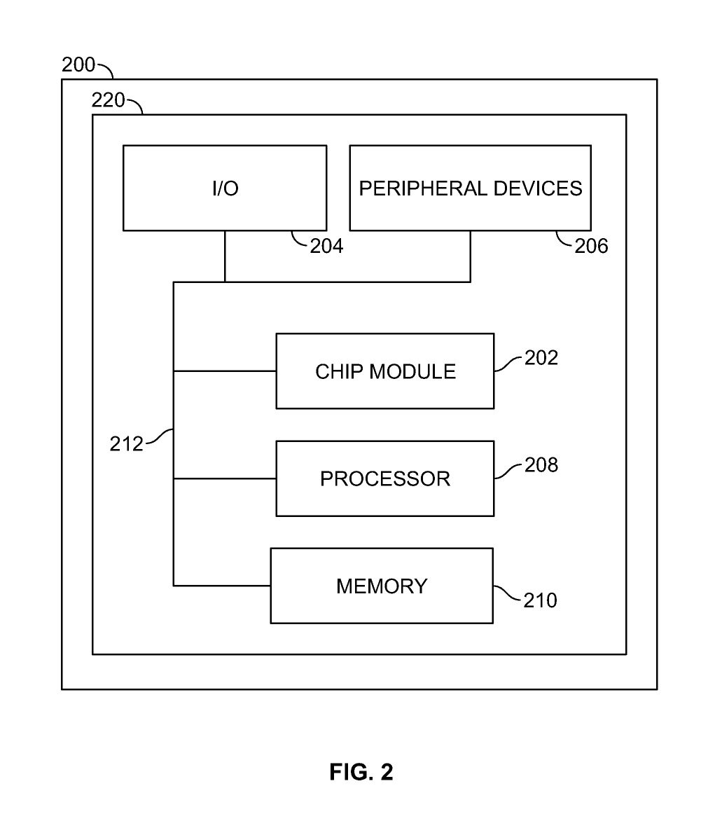

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data; and machine-readable memory 210.

Machine-readable memory 210 may be configured to store in machine-readable data structures: CPG information, financial institution (“FI”) information, entity account information; entity information and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

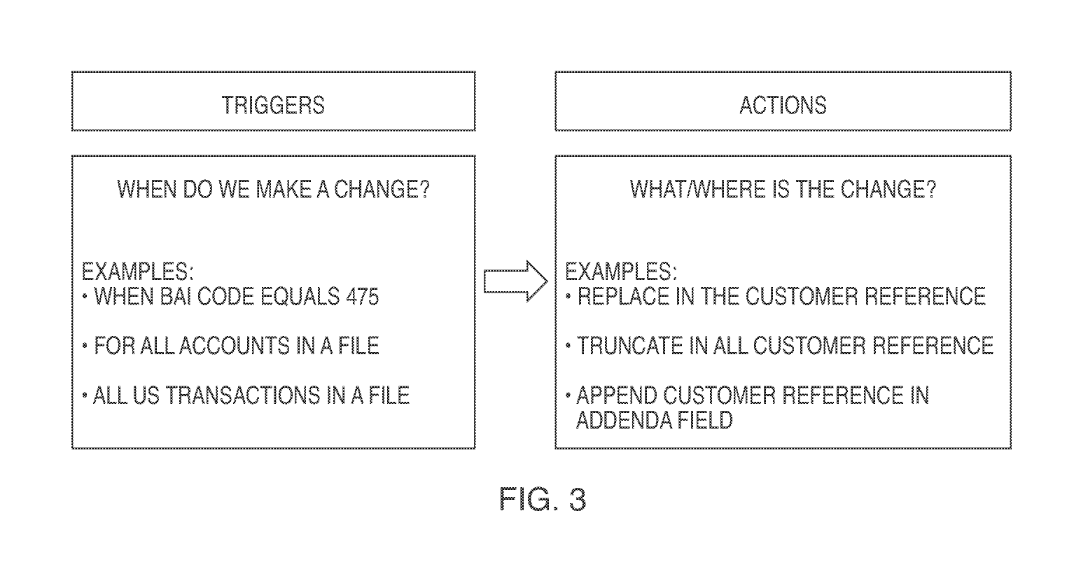

FIG. 3 shows triggers and actions, or executables. The data configuration utility uses a trigger to determine when a change is made, such as, for example, when an entity code is equal to a specific number. A change may also be made for all accounts in a file. A change may also be made for all United States transactions in a file. An action, or executable may show what the change is and where the change takes place. An action or executable may replace the specific customer reference field(s), truncate in all customer reference field, and/or append customer reference in an addenda field.

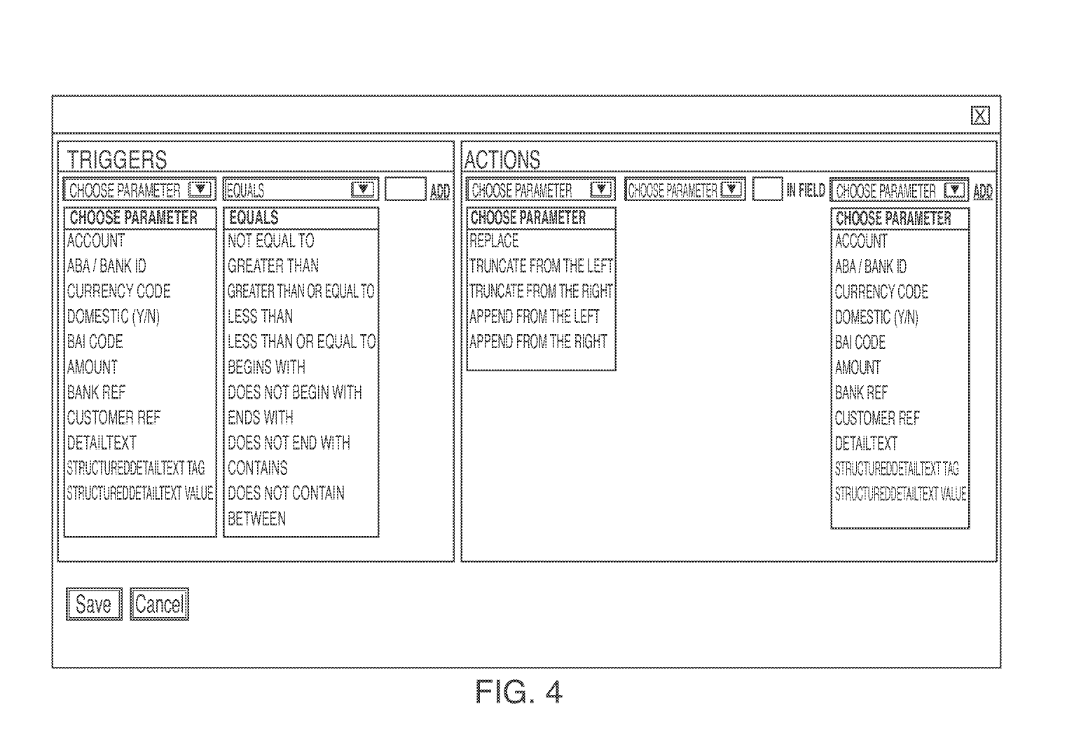

FIG. 4 shows an exemplary user interface which allows a user to determine a trigger. A user may select from a drop-down list of fields. An example of a field may be an account, a currency code, an amount, etc. A user may select from a drop-down list of quantifiers. An example of a quantifier may be equals, not equal to, less than, etc. A user may enter a data element to be quantified. An example of a data element may be 475 (an exemplary currency code) or 1234567 (an exemplary account number), etc.

The user interface also may allow a user to create an executable by selecting from a drop down box of available actions. An example of an action may be replace, truncate from left, append from right, etc. A user may also enter a parameter to be passed to the action. An example of parameter may be zeroes, ones, 1234567 (an exemplary customer identification number). A user may select from a drop down box of available locations where the action should take place. An example of a location may be detail text, account, or currency code.

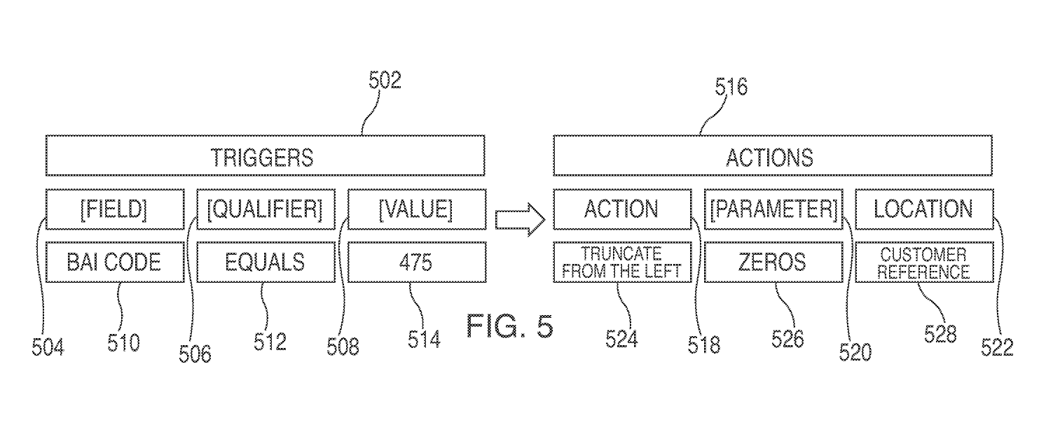

FIG. 5 shows an exemplary embodiment where an entity requests truncating leading zeroes in a customer reference location. Trigger header 502 shows the current trigger comprises field 504, qualifier 506 and value 508. BAI code 510 has been determined to be the field. A BAI code is a file format for electronic cash management reporting. Equals 512 has been determined to be the qualifier. Value 514, the content of which is 475, has been determined to be the value.

Action header 516 shows the current action comprises action 518, parameter 520 and location 522. Action 524 has been determined to be truncate from left. Parameter 526 has been determined to be zeroes. Location 528 has been determined to be customer reference. In this embodiment, all relevant transactions contain the BAI code 475, and the processor truncates all leading zeroes from the customer reference field in each transaction.

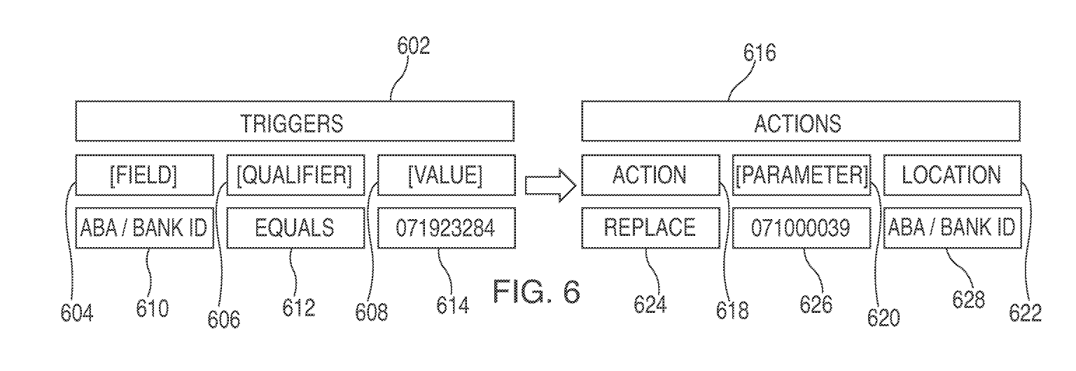

FIG. 6 shows an exemplary embodiment where an entity requests changing the routing number from a state-specific routing number to a general country-wide routing number. Trigger header 602 shows the current trigger comprises field 604, qualifier 606 and value 608. ABA/Bank ID code 610 has been determined to be the field. Equals 612 has been determined to be the qualifier. Value 614, the content of which is 071923284, the state-specific routing number, has been determined to be the value. Action header 616 shows the current action comprises action 618, parameter 620 and location 622. Action 624 has been determined to replace the data in the specified location with parameter 626. Parameter 626 has been determined to be 07100039, the country-wide routing number. Location 628 has been determined to be ABA/Bank ID. In this embodiment, all relevant transactions have the ABA/Bank ID equal to 071923284, and the processor replaces the ABA/Bank ID with 071000039 in each transaction.

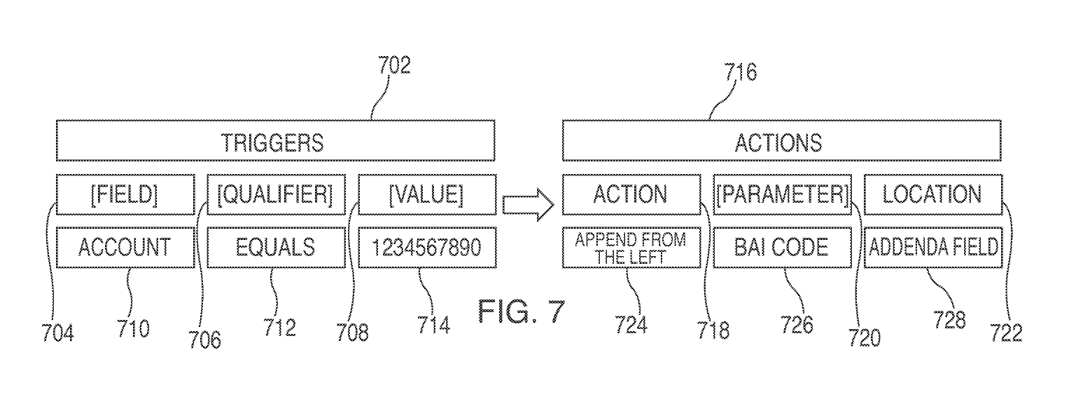

FIG. 7 shows an exemplary embodiment where an entity requests the BAI code to be added to the addenda field for one specific type of account. Trigger header 702 shows the current trigger comprises field 704, qualifier 706 and value 708. Account 710 has been determined to be the field. Equals 712 has been determined to be the qualifier. Value 714 is the account number where the change takes place. Action header 716 shows the current action comprises action 718, parameter 720 and location 722. Action 724 has been determined to be append from left. Parameter 726 has been determined to be the BAI code. Location 728 has been determined to be the addenda field. In this embodiment, all relevant transactions have the account number 1234567890, and the processor appends the BAI code to the addenda field in each relevant transaction.

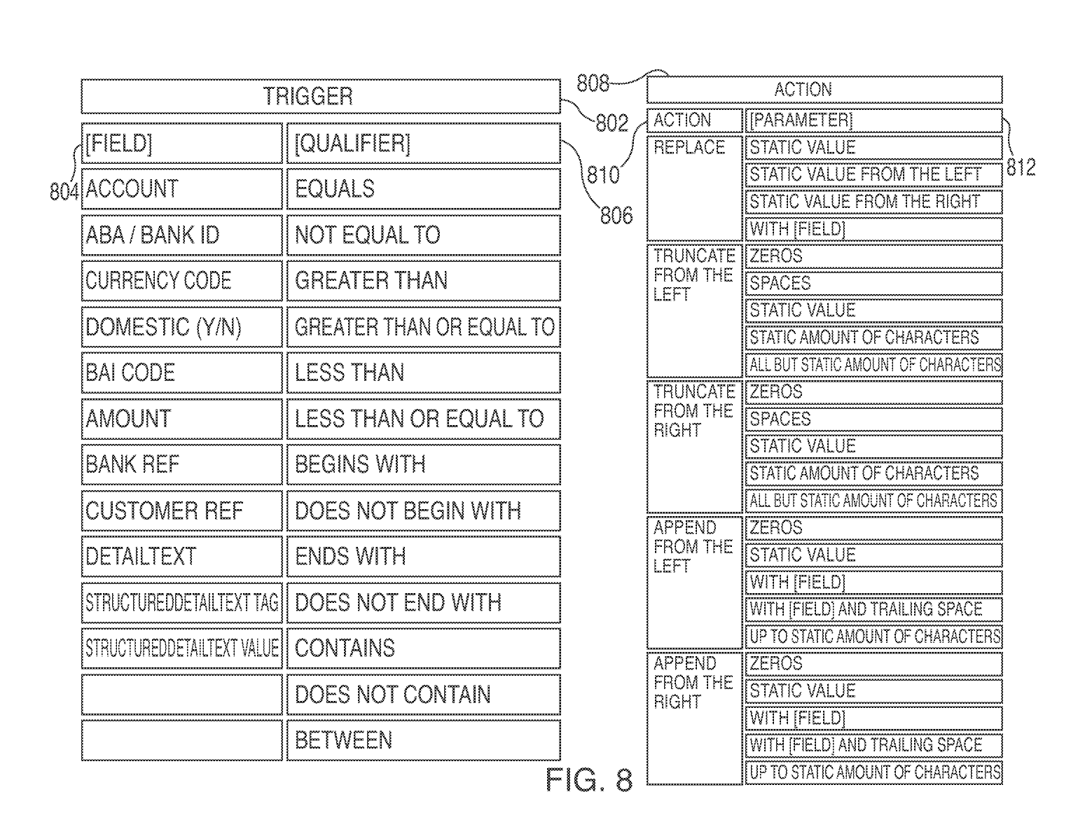

FIG. 8 shows an exemplary list of triggers and actions. Trigger list 802 contains field list 804 and qualifier list 505. Field list 804 contains an exemplary list of fields, for example, account, ABA/Bank ID, currency code, domestic (Y/N), BAI code, amount, bank ref, customer ref, detail text, structured detail text tag, and/or structured detail text value. Action list 808 contains actions list 810 and parameter list 812. Action list 810 contains replace, truncate from the left, truncate from the right, append from the left and append from the right. Parameter list 812 contains parameters which may be passed to the replace action. These parameters include: static value, static value from the left, static value from the right, and with a specific field. Parameter list 812 contains parameters which may be passed to the truncate and append actions. These parameters include: zeroes, spaces, static value, static amount of characters and all but static amount of characters.

What is claimed is:

1. An apparatus for data presentation and manipulation, the apparatus comprising:
a receiver configured to receive:
a trigger comprising:
a field;
a qualifier; and
a value;
an executable comprising:
an action;
a parameter; and
a location;
a database comprising a plurality of transactions; and
a processor configured to determine, using the trigger, from among the plurality of transactions, all relevant transactions wherein each relevant transaction is selected because the relevant transaction comprises the value qualified by the qualifier;
wherein the processor is further configured to alter each relevant transaction by executing the action, wherein the parameter is passed to the action, and the action is executed in the location of each relevant transaction.

2. The apparatus of claim 1, wherein the trigger field is selected from the group consisting of account number, ABA/Bank Identification number, currency code, domestic, foreign, BAI code, amount, bank reference number, customer reference number, structured detail text tag and structured detail text value.

3. The apparatus of claim 1, wherein the trigger qualifier is selected from the group consisting of equals, not equal to, greater than, greater than or equal to, less than, less than or equal to, begins with, does not begin with, ends with, does not end with, contains, does not contain and between.

4. The apparatus of claim 1, wherein the executable action is selected from the group consisting of replace, truncate from left, truncate from right, append from the left, append from the right.

5. The apparatus of claim 1, wherein, when the executable action is replace, then the executable parameter is selected from the group consisting of static value, static value from the left, static value from the right and with.

6. The apparatus of claim 1, wherein, when the executable action is truncate from the left, truncate from the right, append from the left or append from the right, the executable parameter is zeroes.

7. The apparatus of claim 1, wherein, when the executable action is truncate from the left or truncate from right, the executable parameter is selected from a group consisting of zeroes, spaces static value, static amount of characters and all but static amount of characters.

8. The apparatus of claim 1, wherein, when the executable action is append from left and append from right, the executable parameter is selected from a group consisting of zeroes, static value and up to a static amount of characters.

9. An article of manufacture comprising a non-transitory computer usable medium having computer readable program code embodied therein, the code when executed by one or more processors configuring a computer to execute a method for data presentation and manipulation the method comprising:
using a receiver to receive:
a trigger comprising:
a field;
a qualifier; and
a value;
an executable comprising:
an action;
a parameter; and
a location;
using a database to store a plurality of transactions; and
selecting, using a processor, from among the plurality of transactions, all relevant transactions wherein each relevant transaction is selected because the relevant transaction comprises the value qualified by the qualifier, and wherein the selecting using the processor is based on the trigger;
altering, using the processor, each relevant transaction by executing the action, the executing by passing the parameter to the action, and the action is executed in the location of each relevant transaction.

10. The method of claim 9, wherein the trigger field is selected from the group consisting of account number, ABA/Bank Identification number, currency code, domestic, foreign, BAI code, amount, bank reference number, customer reference number, structured detail text tag and structured detail text value.

11. The method of claim 9, wherein the trigger qualifier is selected from the group consisting of equals, not equal to, greater than, greater than or equal to, less than, less than or equal to, begins with, does not begin with, ends with, does not end with, contains, does not contain and between.

12. The method of claim 9, wherein the executable action is selected from the group consisting of replace, truncate from left, truncate from right, append from the left, append from the right.

13. The method of claim 9, wherein, when the executable action is replace, then the executable parameter is selected from the group consisting of static value, static value from the left, static value from the right and with.

14. The method of claim 9, wherein, when the executable action is truncate from the left, truncate from the right, append from the left or append from the right, the executable parameter is zeroes.

15. The method of claim 9, wherein, when the executable action is truncate from the left or truncate from right, the executable parameter is selected from a group consisting of zeroes, spaces static value, static amount of characters and all but static amount of characters.

16. The method of claim 9, wherein, when the executable action is append from left and append from right, the executable parameter is selected from a group consisting of zeroes, static value and up to a static amount of characters.

17. An apparatus for data presentation and manipulation, the apparatus comprising:
a receiver configured to receive:
a trigger comprising:
a field;
a qualifier; and
a value;
an executable comprising:
an action;
a parameter; and
a location;
a database comprising a plurality of transactions; and
a processor configured to determine, using the trigger, from among the plurality of transactions, all relevant transactions wherein each relevant transaction is selected because the relevant transaction comprises the value qualified by the qualifier;
wherein the processor is further configured to alter each relevant transaction by executing the action, wherein the parameter is passed to the action, and the action is executed in the location of each relevant transaction; and
wherein, following the altering of a relevant transaction, the processor is further configured to present the altered relevant transaction to a user via a user interface, whereby the user's interface conforms to execution of the action.

18. The apparatus of claim 17, wherein the trigger field is selected from the group consisting of account number, ABA/Bank Identification number, currency code, domestic, foreign, BAI code, amount, bank reference number, customer reference number, structured detail text tag and structured detail text value.

19. The apparatus of claim 17, wherein the trigger qualifier is selected from the group consisting of equals, not equal to, greater than, greater than or equal to, less than, less than or equal to, begins with, does not begin with, ends with, does not end with, contains, does not contain and between.
